(19) United States
(12) Patent Application Publication
(10) Pub. No.: US 2015/0308174 A1
(43) Pub. Date: Oct. 29, 2015

(54) TRACK STRUCTURE FOR A SLIDEWAY AND A METHOD FOR MAKING THE SAME

(71) Applicant: Sun Chain Metal Industry Co., Ltd., Taipei City (TW)

(72) Inventor: Teng-Yi Juan, Taipei City (TW)

(73) Assignee: SUN CHAIN METAL INDUSTRY CO., LTD., Taipei City (TW)

(21) Appl. No.: 14/261,309

(22) Filed: Apr. 24, 2014

(51) Int. Cl. E05D 15/16; B21D 11/08; B21C 1/00; B21J 5/02; B21B 1/38

(52) U.S. Cl. CPC E05D 15/165; B21J 5/02; B21B 1/38; B21C 1/00; B21D 11/08

(57) ABSTRACT

A track structure for a slideway includes a track body which has a main wall and two lateral walls integrally formed at two sides of the main wall. The track body is formed by folding two sides of a metal plate with a thickness t0 and subjected to shaping process, including hot rolling, cold rolling, hot drawing, cold drawing, or hot and cold forging, to make the main wall has a shrinkage c1, the two lateral walls have a shrinkage c2, c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

### BACKGROUND OF THE INVENTION

1. Field of the Invention

The present invention relates to a track structure for a slideway and a method for making the same, wherein the track is defined by a main wall and two lateral walls integrally formed at two sides of the main wall.

2. Description of the Prior Art

The track structure for a conventional slideway and a method for making the same are as shown in FIG. 1, wherein the track structure is formed by cutting a groove 13 on a flat and elongated metal, so that the metal ingot has a main wall 11 and two lateral walls 12 at two sides of the main wall 11 to define the track of the slideway. Suppose that the main wall 11 and the two lateral walls 12 have an equal thickness a, the inner surface of the main wall 11 intersects the inner surfaces of the two lateral walls 12 at a point O, the maximum distance between the point O and the outer arc is R, and they satisfy the equation as follows: R²=2 a². However, a big part of the metal ingot has to be cut away during the manufacturing process, which is very wasteful and increases the raw material cost.

To improve the raw material usage, as shown in FIG. 2, a metal plate 20 can be used as a raw material, then the left and right sides of the metal plate 20 are bent in the same direction, so that a main wall 21 and two lateral walls 22 at two sides of the main wall 21 are formed on the metal plate 20 to define a track of a slideway. Suppose that the metal plate has a thickness r, the length of the arc at the folded portion of the track is A, and the following equation is satisfied: A=(2πr)/4. It is to be noted that the method of folding a metal plate improves the raw material usage, but also will cause accumulated stress at the folding portion of the track, which reduces the structure strength of the track. On the other hand, it is unable to perform secondary processing, such as drilling, planning, cutting, etc, at the folded portion of the track, and the folded portion has a height and width which are equal to or even larger than that of the main wall and lateral walls, therefore, the area where the secondary processing cannot be performed, is further increased.

The present invention has arisen to mitigate and/or obviate the afore-described disadvantages.

### SUMMARY OF THE INVENTION

The primary objective of the present invention is to provide a track structure for a slideway and a method for making the same, wherein the height and width of the folded portion of the track body are reduced, and as a result, the area where the secondary processing, such as drilling, planning, cutting, etc, can be performed, is increased.

To achieve the above objective, a track structure for a slideway in accordance with the present invention comprises: a track body with a main wall and two lateral walls integrally formed at two sides of the main wall. The track body is formed by folding two sides of a metal plate with a thickness t0 and is subjected to shaping process, including hot rolling, cold rolling, hot drawing, cold drawing, or hot and cold forging, to make the main wall has a shrinkage c1, the two lateral walls have a shrinkage c2, c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

To achieve the above objective, a track structure for a slideway in accordance with another embodiment of the present invention comprises: a track body with a main wall and two lateral walls integrally formed at two sides of the main wall. The track body is formed by folding two sides of a metal plate and then shaping the metal plate which has been folded. The metal plate has a non-uniform thickness, the thickness ratio of the thinnest portion to the thickest portion of the metal plate is smaller than ½, and a thickness of the thinnest portion is t0, the track body is subjected to shaping process, including hot rolling, cold rolling, hot drawing, cold drawing, or hot and cold forging, to make the main wall has a shrinkage c1, the two lateral walls have a shrinkage c2, c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

To achieve the above objective, a method for making the track of the slideway in accordance with the present invention comprises the following steps:

preparing a metal plate with a thickness t0, or processing a metal ingot into a metal ingot into a metal plate with the thickness t0;

forming a track body, which has a main wall and two lateral walls integrally formed at two sides of the main wall, by folding two sides of the metal plate; and

subjecting the track body to hot rolling, cold rolling, hot drawing, cold drawing, or cold and hot forging, so as to make the main wall has a shrinkage c1, the two lateral walls have a shrinkage c2, and c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

By such arrangements, the height and width of the folded portion of the track body are reduced, and as a result, the area of the track body, where the secondary processing can be performed, is increased.

### BRIEF DESCRIPTION OF THE DRAWINGS

FIG. 1 is an illustrative view of a track of a conventional slideway;

FIG. 2 is an illustrative view of the track of another conventional slideway;

FIG. 3 shows a track structure for a slideway in accordance with a preferred embodiment of the present invention;

FIG. 4 shows that the lateral walls of the track body of the present invention are formed with ball cavities;

FIG. 5 shows that the lateral walls of the track body of the present invention are formed with ball cavities;

FIG. 6 shows a track structure for a slideway in accordance with another preferred embodiment of the present invention;

FIG. 7 shows the metal plate in accordance with another preferred embodiment of the present invention, which is used as raw material for making the track body; and

FIG. 8 is a flow chart showing the steps of a method for making the track of the slideway in accordance with the present invention.

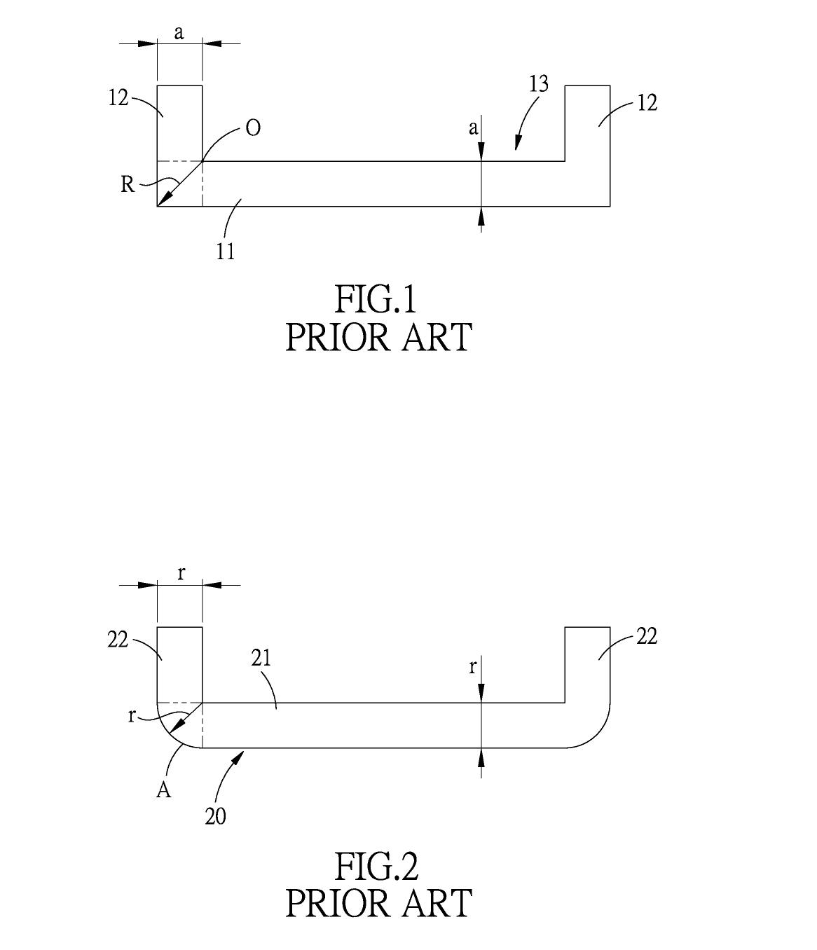

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

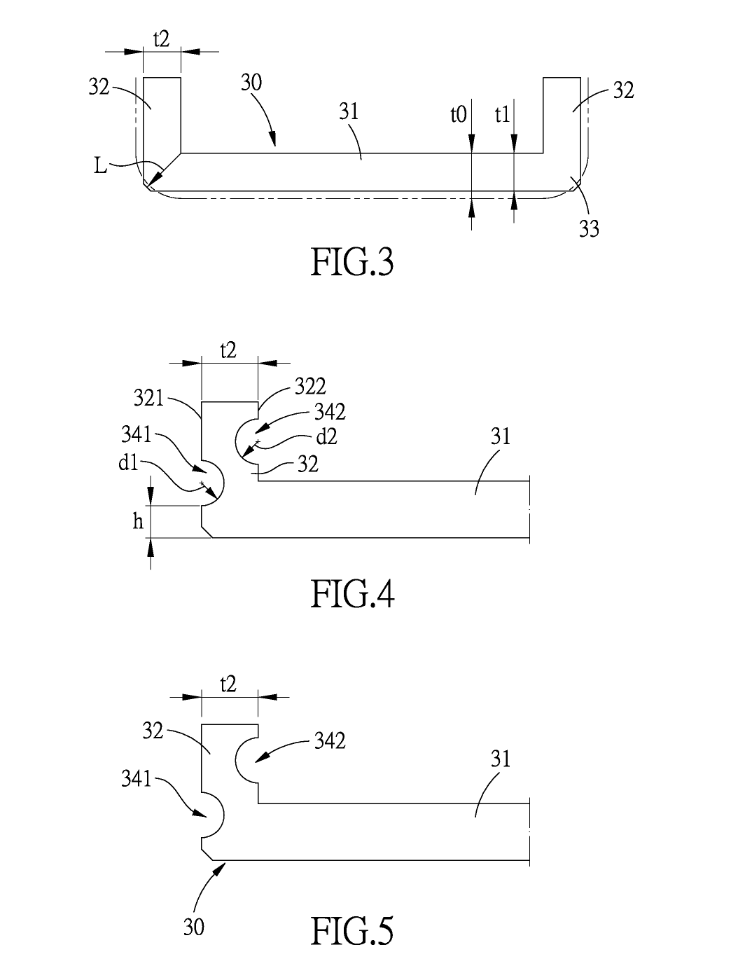

Referring to FIGS. 3 and 4, a track structure for a slideway in accordance with a preferred embodiment of the present invention comprises: a track body 30 which includes a main wall 31 and two lateral walls 32 integrally formed at two sides of the main wall 31. The track body 30 is formed by folding two sides of a metal plate with a thickness t0. The track body 30 is subjected to shaping process, including hot rolling, cold rolling, hot drawing, cold drawing, or hot and cold forging, so that the main wall 31 has a shrinkage c1, the two lateral walls 32 have a shrinkage c2, and c1 and c2 are between ⅕ and ⅛. The main wall 31 has a thickness t1, the lateral walls 32 have a thickness t2, and t1=(1−c1)t0, t2=(1−c2)t0. The thicknesses t1 and t2 are between 2 mm and 8 mm, the track body 30 has a shaping section with a length L at each of the folded portions of the track body 30, and t0<L<(t1²+t2²)^{1/2}. In this embodiment, t0 is 6 mm, t1 and t2 are 5 mm, L is 6.5 mm, then (t1²+t2²)^{1/2} is approximately 7.07 mm.

Each of the lateral walls 32 includes an outer surface 321 and an inner surface 322. In the outer surface 321 is formed an outer ball cavity 341 which can be located at the bottom of the outer surface 321, a distance between the outer ball cavity 341 and the main wall 31 is h, and 0<h/t1<0.5, preferably h/t1 is approximately 0.336. In this embodiment, h is 0.98 mm, and h/t1=0.196.

In the inner surface 322 of each of the lateral walls 32 is formed an inner ball cavity 342 with a depth d2, the depth of the outer ball cavity 341 is d1, and t2>d1+d2.

By such arrangements, the height and width of the folded portion of the track body 30 are reduced, and as a result, the area of the track body 30, where the secondary processing can be performed, is increased.

It is to be noted that the locations of the outer and inner ball cavities 341, 342 can be changed as desired. As shown in FIG. 5, for example, the height and width of the folded portion of the track body 30 are reduced, which increases the area at the lateral walls 32 within which the secondary processing can be performed. The user can also increase the distance between the inner and outer ball cavities 342, 341 to prevent the secondary processing from affecting the track body 30, especially the structural strength of the lateral walls 32.

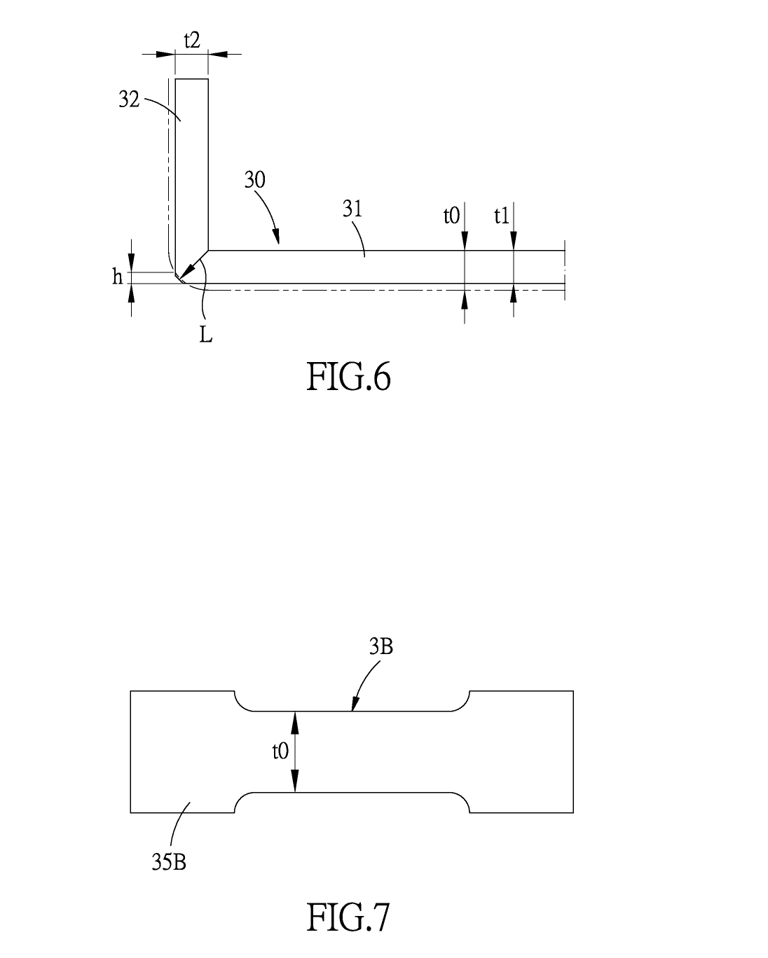

Referring then to FIG. 6, the main wall 31 has a thickness t1, the lateral walls 32 have a thickness t2, and the track body 30 has a shaping section with a length L at each of the folded portions of the track body 30. In this embodiment, t0 is 3 mm, t1 and t2 are 2.5 mm, L is 3.5 mm, then (t1²+t2²)^{1/2} is approximately 3.54 mm.

Since the outer bal cavity 341 is located at the bottom of the outer surface 321 of each of the lateral walls 32, the distance between the bottom of the outer surface 321 and the main wall 31 is h, in this embodiment, h is 0.13 mm, and h/t1=0.052.

Referring then to FIG. 7, which is another embodiment of the present invention, wherein the track body is formed by folding two sides of a metal plate 3B and then shaping the folded metal plate 3B. The metal plate 3B has a non-uniform thickness, the thickness ratio of the thinnest portion to the thickest portion of the metal plate 3B is smaller than ½, and the thickness of the thinnest portion is t0. More specifically, the metal plate 3B is provided with a plurality of protrusions 35B at the left and right sides thereof, and the protrusions 35B have a thickness larger than t0. In this embodiment, t0 is 5 mm, the thickness and width of the protrusions 35B are 6.5 mm and 6 mm, and the thickness ratio of the thinnest portion to the thickest portion of the metal plate 3B is 0.23.

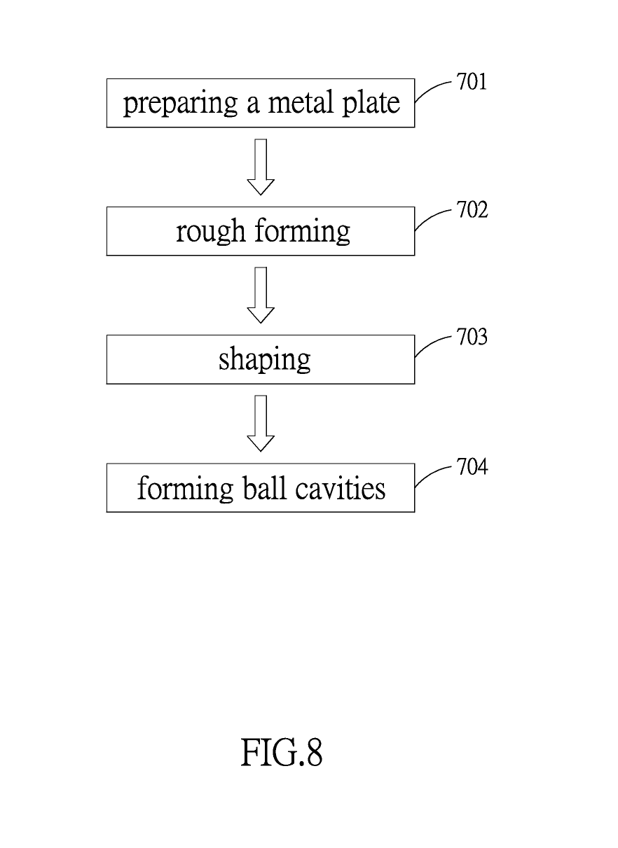

What mentioned above is the track structure of a slideway of the present invention, and for the method of making the track structure, reference should be made to FIG. 8. The method of the present invention comprises the following steps:

Step 701 of preparing a metal plate: directly using a metal plate with a thickness t0, or processing a metal ingot into a metal ingot into a metal plate with a thickness t0;

Step 702 of rough forming: forming a track body 30, which has a main wall 31 and two lateral walls 32 integrally formed at two sides of the main wall 31, by folding two sides of the metal plate;

Step 703 of shaping: subjecting the track body 30 to hot rolling, cold rolling, hot drawing, cold drawing, or cold and hot forging, so as to make the main wall has a shrinkage c1, the two lateral walls 32 have a shrinkage c2, and c1 and c2 are between ⅕ and ⅛, the main wall 31 has a thickness t1, the lateral walls 32 have a thickness t2, and t1=(1−c1)t0, t2=(1−c2)t0, the track body 30 has a shaping section with a length L at each of the folded portions of the track body 30, and t0<L<(t1²+t2²)^{1/2}; and

Step 704 of forming ball cavities: forming outer and inner ball cavities 341, 342 in the lateral walls 32 by machining the track body 30, and the outer ball cavity 341 can be formed at the bottom of the outer surface 321 of each of the lateral walls 32. The forming of the track of the slideway now has been finished.

While we have shown and described various embodiments in accordance with the present invention, it is clear to those skilled in the art that further embodiments may be made without departing from the scope of the present invention.

What is claimed is:

1. A track structure for a slideway comprising:
a track body with a main wall and two lateral walls integrally formed at two sides of the main wall, the track body being formed by folding two sides of a metal plate with a thickness t0, the track body being subjected to shaping process, including hot rolling, cold rolling, hot drawing, cold drawing, or hot and cold forging, to make the main wall has a shrinkage c1, the two lateral walls have a shrinkage c2, c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

2. The track structure for the slideway as claimed in claim 1, wherein t1 and t2 are between 2 mm and 8 mm.

3. The track structure for the slideway as claimed in claim 1, wherein each of the lateral walls includes an outer surface and an inner surface, in the outer surface is formed an outer ball cavity, a distance between the outer ball cavity and the main wall is h, and 0<h/t1<0.5.

4. The track structure for the slideway as claimed in claim 3, wherein h/t1=0.336.

5. The track structure for the slideway as claimed in claim 3, wherein an inner ball cavity with a depth d2 is formed in the inner surface of each of the lateral walls, a depth of the outer ball cavity is d1, and t2>d1+d2.

6. The track structure for the slideway as claimed in claim 1, wherein the metal plate is provided with a plurality of protrusions which have a thickness larger than t0.

7. A method for making a track of a slideway comprising the following steps:
preparing a metal plate with a thickness t0, or processing a metal ingot into a metal ingot into a metal plate with the thickness t0;
forming a track body, which has a main wall and two lateral walls integrally formed at two sides of the main wall, by folding two sides of the metal plate; and
subjecting the track body to hot rolling, cold rolling, hot drawing, cold drawing, or cold and hot forging, so as to make the main wall has a shrinkage c1, the two lateral walls have a shrinkage c2, and c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.

8. The method for making the track of the slideway as claimed in claim 7 further comprising forming outer and inner ball cavities in the lateral surfaces by machining the track body, which is carried out after subjecting the track body to hot rolling, cold rolling, hot drawing, cold drawing, or cold and hot forging, and the outer ball cavity is formed at the bottom of the outer surface of each of the lateral walls.

9. The method for making the track of the slideway as claimed in claim 7, wherein c1 and c2 are ⅙, then t1=(⅚)t0, t2=(⅚)t0.

10. A track structure for a slideway comprising:
a track body with a main wall and two lateral walls integrally formed at two sides of the main wall, the track body being formed by folding two sides of a metal plate and then shaping the metal plate which has been folded, the metal plate having a non-uniform thickness, a thickness ratio of the thinnest portion to the thickest portion of the metal plate being smaller than ½, and a thickness of the thinnest portion is t0, the track body being subjected to shaping process, including hot rolling, cold rolling, hot drawing, cold drawing, or hot and cold forging, to make the main wall has a shrinkage c1, the two lateral walls have a shrinkage c2, c1 and c2 are between ⅕ and ⅛, the main wall has a thickness t1, the lateral walls have a thickness t2, and t1=(1−c1)t0, t2=(1−c2)t0, the track body has a shaping section with a length L at each of the folded portions of the track body, and t0<L<(t1²+t2²)^{1/2}.
